(19) United States
(12) Patent Application Publication
(10) Pub. No.: US 2015/0142810 A1
(43) Pub. Date: May 21, 2015

(54) PHOTO FILE DISPLAYING METHOD AND DLNA SYSTEM

(71) Applicant: Primax Electronics Ltd., Taipei (TW)

(72) Inventor: JUNG-CHANG YANG, Taipei (TW)

(73) Assignee: Primax Electronics Ltd., Taipei (TW)

(21) Appl. No.: 14/192,251

(22) Filed: Feb. 27, 2014

(30) Foreign Application Priority Data
Nov. 15, 2013 (TW) 102141709

(51) Int. Cl. G06F 17/30; G06K 9/00

(52) U.S. Cl. CPC G06F 17/30247; G06K 9/00268; G06K 9/00248; G06F 17/30091
USPC 707/738

(57) ABSTRACT

A photo file displaying method includes the following steps. Firstly, a face detection operation is performed on a photo file of a first electronic device. According to a result of the face detection operation, a first photo property or a second photo property is written into a data field of a metadata of the photo file. Then, a first virtual folder and a second virtual folder are displayed on a second electronic device. If the first virtual folder is selected, the photo file corresponding to the first virtual folder is displayed on the second electronic device. If the photo file has the first photo property, the photo file is assigned to the first virtual folder. If the photo file has the second photo property, the photo file is assigned to the second virtual folder.

### FIELD OF THE INVENTION

The present invention relates to a photo file displaying method, and more particularly to a photo file displaying method for a Digital Living Network Alliance (DLNA) system.

### BACKGROUND OF THE INVENTION

Generally, an area network system comprises a local area network (LAN) system, a metropolitan area network (MAN) system and a wide area network (WAN) system. With increasing development of science and technology, the area network system further comprises a universal plug and play (UPnP) system and a Digital Living Network Alliance (DLNA) system. For example, the DLNA system is an alliance organization that is composed by the manufacturers of consumer electronics products, mobile phones and computers. The DLNA is responsible for defining unified transmission specifications to allow a variety of products from different manufacturers to be connected and communicated with each other. Consequently, a first electronic device and a second electronic device that comply with the DLNA protocol can be in direct communication with each other in order to transfer data or make synchronization actions.

First of all, some architectures of the DLNA system will be illustrated as follows. FIG. 1 schematically illustrates the architecture of a first conventional DLNA system. As shown in FIG. 1, the first conventional DLNA system 1 comprises a network router 10, a digital media server (DMS) 11, and a digital media player (DMP) 12. The network router 10 is connected to an internet (not shown). In addition, the network router 10 is in communication with the digital media server 11 and the digital media player 12. Consequently, the communication between the digital media server 11 and the digital media player 12 is established through the network router 10. The digital media server 11 comprises a first storage element 111 for storing a media file 15. The media file 15 is for example an audio file, a photo file or a video file. After the digital media player 12 is in communication with the digital media server 11, the digital media player 12 may search the media file 15 from the digital media server 11. After the media file 15 is selected by the user through the digital media player 12, the media file 15 is transmitted from the digital media server 11 to a second storage element 121 of the digital media player 12. After the media file 15 is received by the digital media player 12, the media file 15 that is temporarily stored in the second storage element 121 can be played by the digital media player 12.

FIG. 2 schematically illustrates the architecture of a second conventional DLNA system. As shown in FIG. 2, the second conventional DLNA system 2 comprises a network router 20, a digital media server (DMS) 21, and a digital media renderer (DMR) 23. The communication between the digital media server 21 and the digital media renderer 23 is established through the network router 20. Similarly, the digital media server 21 comprises a first storage element 211 for storing a media file 25. In addition, the digital media server 21 further provides a control function of controlling operations of the digital media renderer 23. The digital media renderer 23 is used for receiving and playing the media file 25 that is transmitted from the digital media server 21. After the control function of the digital media server 21 is utilized to select the stored media file 25 from the digital media server 21, the media file 25 is transmitted from the digital media server 21 to the digital media renderer 23. Consequently, the media file 25 can be played by the digital media renderer 23.

FIG. 3 schematically illustrates the architecture of a third conventional DLNA system. As shown in FIG. 3, the third conventional DLNA system 3 comprises a network router 30, a digital media server (DMS) 31, a digital media renderer (DMR) 33, and a digital media controller (DMC) 34. The communication between the digital media server 31, the digital media renderer 33 and the digital media controller 34 is established through the network router 30. The digital media server 31 comprises a first storage element for storing a media file 35. The digital media renderer 33 is used for receiving and playing the media file 35 that is transmitted from the digital media server 31. The digital media controller 34 provides a control function. After the control function of the digital media controller 34 is utilized to select the stored media file 35 from the digital media server 31, the media file 35 is transmitted from the digital media server 31 to the digital media renderer 33. Consequently, the media file 35 can be played by the digital media renderer 33.

As mentioned above, the digital media server, the digital media controller, the digital media renderer and the digital media player included in the same DLNA system may transfer or play media files through the network router. The digital media server and the digital media renderer may be referred as passive electronic devices that can be controlled. Moreover, the digital media controller and the digital media player may be referred as active electronic devices that can control the passive electronic devices. For example, a user in a living room may allow a mobile phone to be connected to a computer host in a study room. Moreover, through the mobile phone, the user may browse the audio files in the computer and select a desired audio file from the computer. Then, the selected audio file is transmitted from the mobile phone to a stereo device in the living room. After the audio file is received by the stereo set, the audio file is played by the stereo device. Consequently, the purposes of conveniently and quickly sharing media contents can be achieved by the DLNA system.

In case that the first storage element of the digital media server stores a great number of media files, it is difficult to search the desired media file. For example, if the user intends to play the media file of the digital media server through the use of the digital media controller or the digital media player, since the number of the media files is too large, the desired media file to be played cannot be easily searched by the user. For facilitating the user to search the desired media file, at least three folders have been previously stored in the first storage element of the commercially available digital media server. The at least three folders comprise an audio folder corresponding to the audio files, a photo folder corresponding to the photo files and a video folder corresponding to the video files. When an audio file is newly added to the digital media server, the audio file is automatically assigned to the audio folder. Similarly, when a photo file and a video file are newly added to the digital media server, the photo file is automatically assigned to the photo folder and the video file is automatically assigned to the video folder.

However, since the number of the photo files is much larger than the number of the video file and the number of the audio files, the single photo folder of the first storage element usually stores a great number of photo files. Consequently, if the user intends to play the media file of the digital media server through the use of the digital media controller or the digital media player, it is still difficult for the user to search the desired media file from the photo folder.

Therefore, there is a need of providing a photo file displaying method for facilitating the user to view photo files and a DLNA system for displaying the photo files.

### SUMMARY OF THE INVENTION

An object of the present invention provides a photo file displaying method for facilitating the user to view photo files.

Another object of the present invention provides a DLNA system for displaying the photo files.

In accordance with an aspect of the present invention, there is provided a photo file displaying method for a DLNA system. The photo file displaying method includes the following steps. Firstly, a face detection operation is performed on a photo file of a first electronic device. According to a result of the face detection operation, a first photo property or a second photo property is written into a data field of a metadata of the photo file. Then, a first virtual folder and a second virtual folder are displayed on a second electronic device. If the photo file has the first photo property, the photo file is assigned to the first virtual folder. If the photo file has the second photo property, the photo file is assigned to the second virtual folder. If the first virtual folder or the second virtual folder is selected, the photo file corresponding to the first virtual folder or the second virtual folder is displayed on the second electronic device.

In accordance with another aspect of the present invention, there is provided a DLNA system for displaying a photo file. The DLNA system includes a network router, a digital media server, and an electronic device. The network router provides a network connection function. The digital media server is connected to the network router through network connection for storing the photo file. The digital media server includes a storage element, a face analysis module and a controlling unit. The storage element is disposed within the digital media server. The photo file is stored in the storage element. The face analysis module is connected with the storage element. The face analysis module detects whether at least one face image is contained in the photo file. The controlling unit is connected with the face analysis module. The controlling unit writes a first photo property or a second photo property into a metadata of the photo file according to a detecting result of the face analysis module. If the photo file has the first photo property, the photo file is assigned to the first virtual folder. If the photo file has the second photo property, the photo file is assigned to the second virtual folder. The electronic device is connected to the network router through network connection and connected to the digital media server via the network router through network connection. The first virtual folder and the second virtual folder are displayed on the electronic device. If the first virtual folder or the second virtual folder is selected, the photo file corresponding to the first virtual folder or the second virtual folder is displayed on the electronic device.

From the above descriptions, the present invention provides a DLNA system and a photo file displaying method. According to the detecting results of the face detection operations, the metadata of plural photo files are set. When the user operates a digital media controller or a digital media player to browse plural photo files, the metadata are classified into plural groups, and plural virtual folders are displayed on a digital media server according to the classification. Each of the virtual folders contains the photo folders having the photo property corresponding to the metadata. Consequently, plural photo files with the same photo property are assigned to the same virtual folder. In other words, the photo file displaying method of the present invention may facilitate the user to browse the plural photo files and easily search the desired photo file.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a first conventional DLNA system;

FIG. 2 schematically illustrates the architecture of a second conventional DLNA system;

FIG. 3 schematically illustrates the architecture of a third conventional DLNA system;

FIG. 4 is a schematic functional block diagram illustrating a DLNA system according to a first embodiment of the present invention;

FIG. 5 is a flowchart illustrating a photo file displaying method according to the first embodiment of the present invention;

FIG. 6 is a table indicating the metadata of the plural photo files of the DLNA system according to the first embodiment of the present invention;

FIG. 7 schematically illustrates the folder architecture of the digital media server of the DLNA system according to the first embodiment of the present invention;

FIG. 8 is a schematic functional block diagram illustrating a DLNA system according to a second embodiment of the present invention;

FIG. 9 is a flowchart illustrating a photo file displaying method according to the second embodiment of the present invention;

FIG. 10 is a flowchart illustrating the step B* of the photo file displaying method according to the second embodiment of the present invention;

FIG. 11 is a flowchart illustrating the step D* of the photo file displaying method according to the second embodiment of the present invention;

FIG. 12 is a table indicating the metadata of the plural photo files of the DLNA system according to the second embodiment of the present invention;

FIG. 13 schematically illustrates the folder architecture of the first electronic device of the DLNA system according to the second embodiment of the present invention;

FIG. 14 is a flowchart illustrating a photo file displaying method according to a third embodiment of the present invention;

FIG. 15 is a flowchart illustrating the step D* of the photo file displaying method according to the third embodiment of the present invention; and

FIG. 16 schematically illustrates the folder architecture of the digital media server of the DLNA system according to the third embodiment of the present invention.

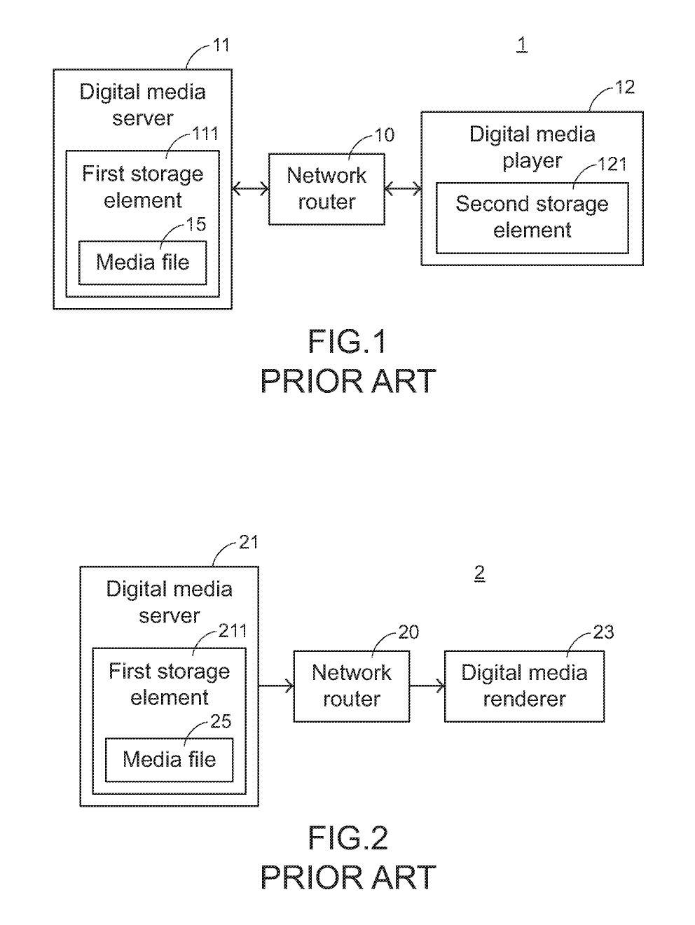

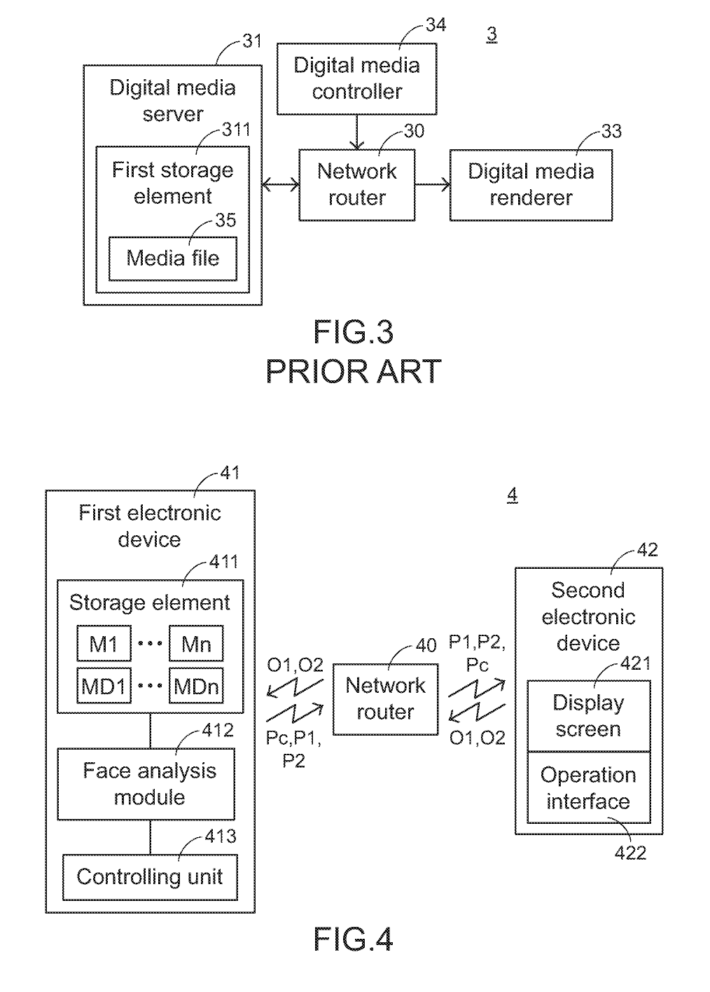

### DETAILED DESCRIPTION OF THE PREFERRED EMBODIMENT

For obviating the drawbacks encountered from the prior art, the present invention provides a photo file displaying method and a Digital Living Network Alliance (DLNA) system using the photo file displaying method.

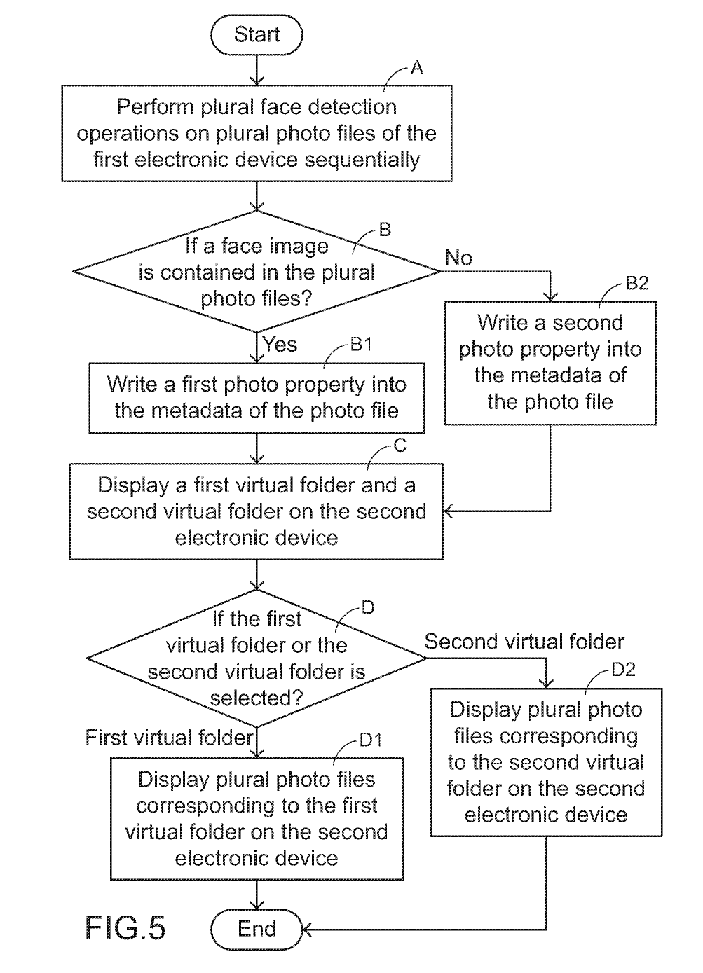

Hereinafter, a DLNA system of the present invention will be illustrated. FIG. 4 is a schematic functional block diagram illustrating a DLNA system according to a first embodiment of the present invention. As shown in FIG. 4, the DLNA system 4 comprises a network router 40, a first electronic device 41, and a second electronic device 42. The first electronic device 41 comprises a storage element 411, a face analysis module 412, and a controlling unit 413. The network router 40 is used to provide a network connection function. Via the network router 40, the first electronic device 41 and the second electronic device 42 are connected with each other through network connection. The first electronic device 41 is connected to the network router 40 through network connection. Moreover, plural photo files M1˜Mn are stored in the first electronic device 41. The storage element 411 is included in the first electronic device 41 for storing the plural photo files M1˜Mn. The face analysis module 412 is connected with the storage element 411 for detecting whether at least one face image is contained in the plural photo files M1˜Mn. The controlling unit 413 is connected to the face analysis module 412. According to the detecting result of the face analysis module 412, the controlling unit 413 writes a first photo property or a second photo property into the metadata MD1˜MDn of the plural photo files M1˜Mn. In this embodiment, the first electronic device 41 is a digital media server, the storage element 411 is a hard disc, the face analysis module 412 is a firmware component or a hardware component included in the first electronic device 41, and the controlling unit 413 is a microprocessor.

The second electronic device 42 is connected to the network router 40 through network connection. Moreover, via the network router 40, the second electronic device 42 is connected with the first electronic device 41 through network connection. The second electronic device 42 comprises a display screen 421 and an operation interface 422. The plural photo files M1˜Mn of the storage element 411 may be displayed on the display screen 421. Via the operation interface 422, the user may operate the plural photo files M1˜Mn in order to generate corresponding operation commands. In this embodiment, the second electronic device 42 is a digital media controller. The display screen 421 and the operation interface 422 are combined as a touch screen. Moreover, the network router 40 complies with the universal plug and play (UPnP) protocol. Moreover, both of the first electronic device 41 and the second electronic device 42 comply with the Digital Living Network Alliance (DLNA) protocol.

Hereinafter, a photo file displaying method according to the present invention will be illustrated with reference to FIG. 5. FIG. 5 is a flowchart illustrating a photo file displaying method according to a first embodiment of the present invention. The photo file displaying method comprises the following steps.

Firstly, in a step A, plural face detection operations are performed on plural photo files of the first electronic device sequentially. Then, a step B is performed to judge whether a face image is contained in the plural photo files. In a step B1, a first photo property is written into the metadata of the photo file. In a step B2, a second photo property is written into the metadata of the photo file. In a step C, a first virtual folder and a second virtual folder are displayed on the second electronic device. In a step D, the first virtual folder or the second virtual folder is selected. In a step D1, plural photo files corresponding to the first virtual folder are displayed on the second electronic device. In the step D2, plural photo files corresponding to the second virtual folder are displayed on the second electronic device.

If the judging condition of the step B is satisfied, the step B1 is performed. Whereas, if the judging condition of the step B is not satisfied, the step B2 is performed. If the first virtual folder is selected in the step D, the step D1 is performed. If the second virtual folder is selected in the step D, the step D2 is performed. The metadata of the photo file describes the data property in order to indicate the storage location, the history data, the resource search, the file record or any other appropriate information. In other words, the metadata is an electronic list for achieving a list editing function. The metadata describes the contents or the features of the photo folder in order to facilitate searching the photo folder.

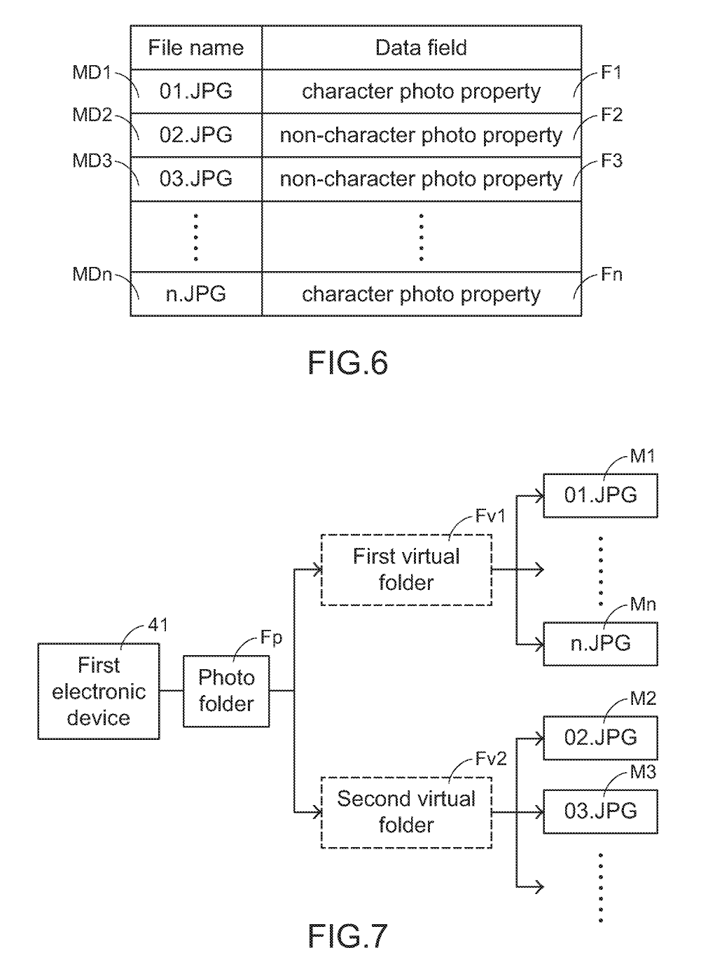

Before the photo file displaying method is started, it is necessary to store the plural photo files M1˜Mn into the storage element 411 of the first electronic device 41. The file names of the plural photo files M1˜Mn are 01.JPG˜n.JPG, respectively (see FIG. 6). The website address of the photo file M1 stored in the first electronic device 41 is http:\\DMS\Photo\01.JPG. The website address of the photo file M2 stored in the first electronic device 41 is http:\\DMS\Photo\02.JPG. The rest may be deduced by analogy. The term “DMS” in the above website addresses denotes the first electronic device 41. The term “Photo” in the above website addresses denotes a default photo folder Fp of the storage element 411. That is, the photo file M1 with the file name “01.JPG” is stored in the photo folder Fp of the first electronic device 41. The rest may be deduced by analogy. The method of storing the plural photo files M1˜Mn into the storage element 411 is well known to those skilled in the art, and is not redundantly described herein.

Hereinafter, the detailed procedure of the photo file displaying method performed by the DLNA system 4 will be illustrated with reference to FIGS. 4 and 5. After the plural photo files M1˜Mn are stored into the storage element 411, the photo file displaying method is started. First of all, the face analysis module 412 performs the face detection operations on the plural photo files M1˜Mn stored in the storage element 411 of the first electronic device 41 sequentially. That is, the step A is performed. Then, the face analysis module 412 judges whether a face image is contained in the plural photo files M1˜Mn. That is, the step B is performed. If the face analysis module 412 judges that there is a face image in the photo file M1, the first photo property is written into the data field F1 of the metadata MD1 of the photo file M1 (see FIG. 6) by the controlling unit 413. That is, the step B1 is performed. For example, the first photo property is a character photo property. Whereas, if the face analysis module 412 judges that there is no face image in the photo file M2, the second photo property is written into the data field F2 of the metadata MD2 of the photo file M2 (see FIG. 6) by the controlling unit 413. That is, the step B2 is performed. For example, the second photo property is a non-character photo property (i.e. a scenic property). The above face detection operations are performed on the remaining photo files M3˜Mn by the face analysis module 412. After the face detection operations on the plural photo files M1˜Mn are completed, plural metadata MD1˜MDn are obtained (see FIG. 6).

After the data fields F1˜Fn of the plural metadata MD1˜MDn are set, if the second electronic device 42 is connected to the first electronic device 41 via the network router 40 through network connection, the plural metadata MD1˜MDn are classified into two groups by the controlling unit 413 of the first electronic device 41 according to the data fields F1˜Fn of the plural metadata MD1˜MDn. One of the two groups is a character photo property group. The other group is a non-character photo property group. According to the above classification, the controlling unit 413 generates a folder packet Pc. The folder packet Pc is transmitted to the second electronic device 42. According to the folder packet Pc, the first virtual folder Fv1 and the second virtual folder Fv2 are displayed on the display screen 421 of the second electronic device 42. That is, the step C is performed. The first virtual folder Fv1 contains plural photo files having the character photo property. The second virtual folder Fv2 contains plural photo files having the non-character photo property. That is, the second virtual folder Fv2 is a scenic photo folder.

Then, if the first virtual folder Fv1 is selected by the user via the operation interface 422 of the second electronic device 42, the second electronic device 42 issues a first select signal O1 to the first electronic device 41. In response to the first select signal O1, the plural photo files having the first photo property (including the photo files M1, . . . , Mn) are acquired and formed as a first list packet P1 by the controlling unit 413, and the first list packet P1 is transmitted to the second electronic device 42. In response to the first list packet P1, the plural photo files (including the photo files M1, . . . , Mn) corresponding to the first virtual folder Fv1 are displayed on the display screen 421 of the second electronic device 42. That is, the step D1 is performed. The website address of the photo file M1 displayed on the second electronic device 42 is http:\\DMS\Photo\first virtual folder\01.JPG.

Whereas, if the second virtual folder Fv2 is selected by the user via the operation interface 422, the second electronic device 42 issues a second select signal O2 to the first electronic device 41. In response to the second select signal O2, the plural photo files having the second photo property (including the photo files M2, M3, . . . ) are acquired and formed as a second list packet P2 by the controlling unit 413, and the second list packet P2 is transmitted to the second electronic device 42. In response to the second list packet P2, the plural photo files (including the photo files M2, M3, . . . ) corresponding to the second virtual folder Fv2 are displayed on the display screen 421 of the second electronic device 42. That is, the step D2 is performed. The website address of the photo file M2 displayed on the second electronic device 42 is http:\\DMS\Photo\second virtual folder\02.JPG.

Meanwhile, the photo file displaying method of the present invention is completed. In addition, the user may perform a subsequent operation on the selected photo file via the operation interface 422.

FIG. 7 schematically illustrates the folder architecture of the digital media server of the DLNA system according to the first embodiment of the present invention. The DLNA system 4 of the present invention is capable of classifying the plural photo files M1˜Mn by implementing the photo file displaying method of the present invention. The folder architecture of the first electronic device 41 is clearly shown in FIG. 7. The first storage element 411 of the first electronic device 41 contains the real photo folder Fp. The photo folder Fp contains the first virtual folder Fv1 (indicated by dotted line) and the second virtual folder Fv2 (indicated by dotted line), which are practically non-existing. That is, the first electronic device 41 only contains the photo folder Fp. For facilitating the user to search the desired photo, the virtual folders Fv1˜Fv2 that do not exist in the first electronic device 41 are further displayed on the display screen 421 of the second electronic device 42. Consequently, the photo file displaying method of the present invention is capable of classifying the plural photo files. Since the plural photo files with different photo properties are assigned to different virtual photo folders, the user can easily search the desired photo file.

In the above embodiment of the DLNA system and the photo file displaying method of the present invention, the storage element has the default photo folder. Alternatively, in some other embodiments of the DLNA system and the photo file displaying method of the present invention, the storage element does not have the default photo folder.

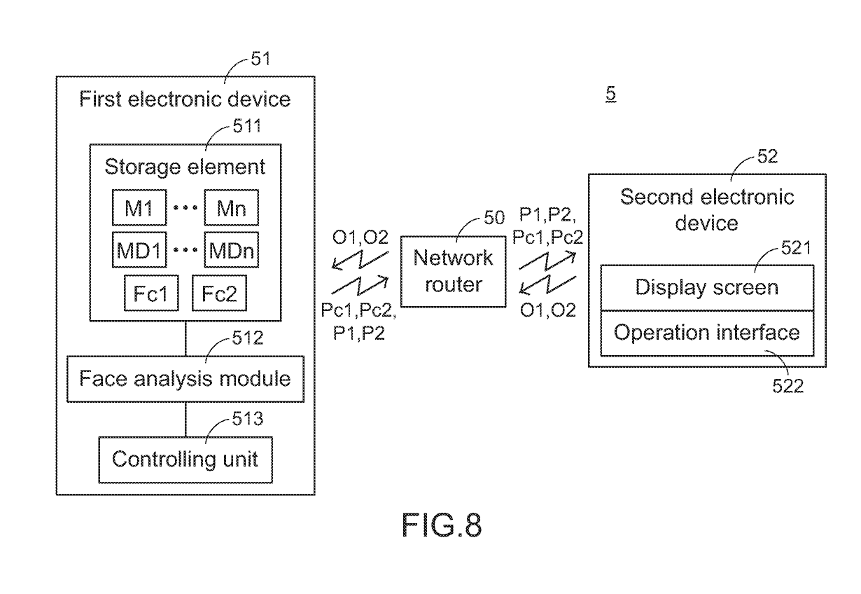

The present invention further provides a second embodiment, which is distinguished from the first embodiment. FIG. 8 is a schematic functional block diagram illustrating a DLNA system according to a second embodiment of the present invention. As shown in FIG. 8, the DLNA system 5 comprises a network router 50, a first electronic device 51 and a second electronic device 52. The first electronic device 51 comprises a storage element 511, a face analysis module 512, and a controlling unit 513. Except for the following two aspects, the architecture of the DLNA system 5 of this embodiment is identical to the architecture of the DLNA system 4 of the first embodiment, and is not redundantly described herein. Firstly, in addition to the function of storing the plural photo files M1˜Mn, the storage element 511 further stores a default facial feature Fc1. Secondly, the second electronic device 52 is a digital media player.

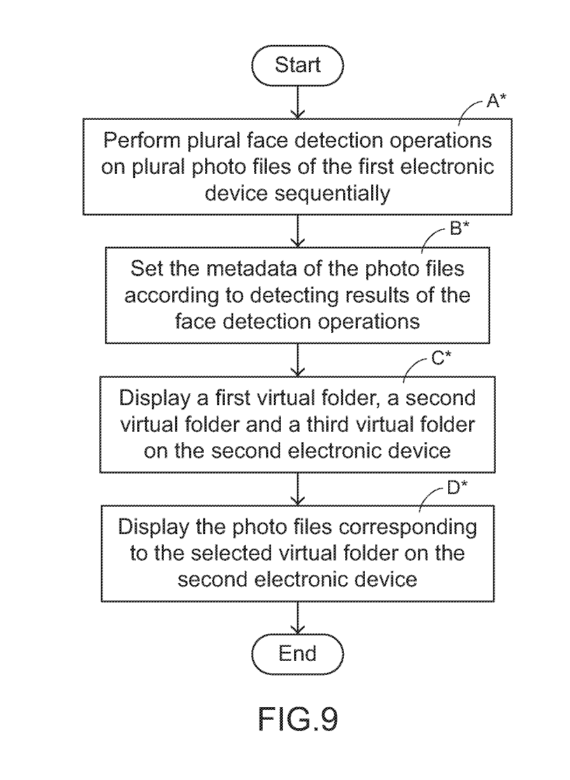

Hereinafter, another photo file displaying method according to the present invention will be illustrated with reference to FIG. 9. FIG. 9 is a flowchart illustrating a photo file displaying method according to a second embodiment of the present invention. The photo file displaying method comprises the following steps.

Firstly, in a step A*, plural face detection operations are performed on plural photo files of the first electronic device sequentially. Then, in a step B*, the metadata of the photo files are set according to the detecting results of the face detection operations. In a step C*, a first virtual folder, a second virtual folder and a third virtual folder are displayed on the second electronic device. In a step D*, the photo files corresponding to the selected virtual folder are displayed on the second electronic device.

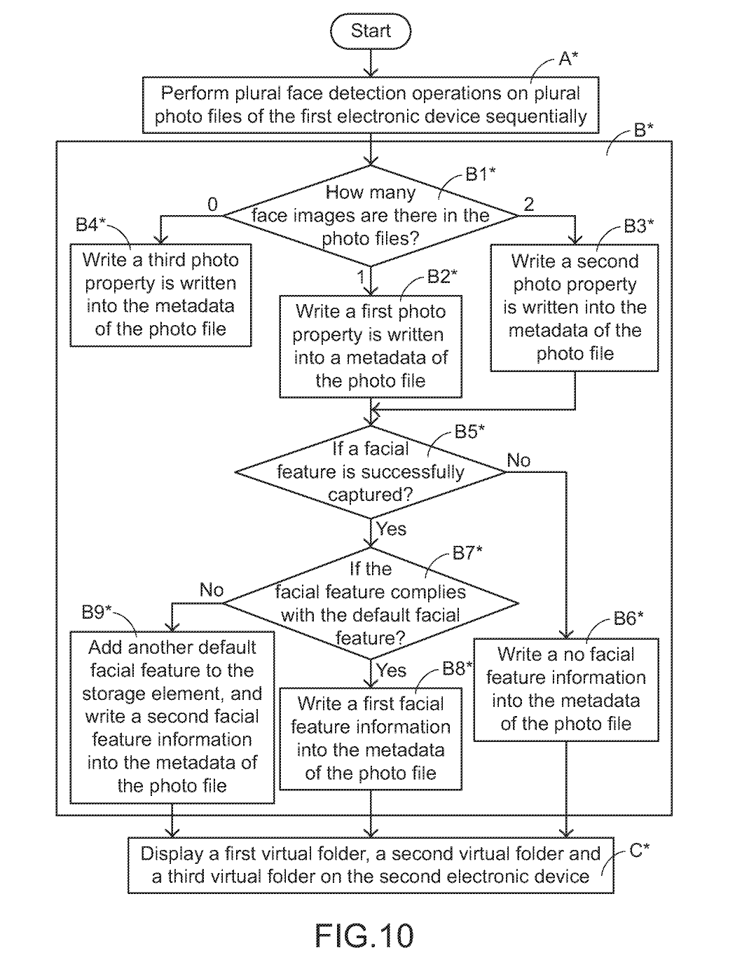

FIG. 10 is a flowchart illustrating the step B* of the photo file displaying method according to the second embodiment of the present invention. The step B* comprises the following steps B1*˜B9*. Firstly, the step B1* is performed to judge the number of face images contained in the photo files. In the step B2*, a first photo property is written into a metadata of the photo file. In the step B3*, a second photo property is written into the metadata of the photo file. In the step B4*, a third photo property is written into the metadata of the photo file. The step B5* is performed to capture a facial feature of the face image of the photo file and judge whether the facial feature is successfully captured. In the step B6*, a no facial feature information is written into the metadata of the photo file. The step B7* is performed to judge whether the facial feature complies with the default facial feature. In the step B8*, a first facial feature information corresponding to the first facial feature is written into the metadata of the photo file. In the step B9*, another default facial feature is newly added to the storage element, and a second facial feature information corresponding to the second facial feature is written into the metadata of the photo file.

If the number of face images contained in the photo files is 1 in the step B1*, the step B2* is performed. Whereas, if the number of face images contained in the photo files is 2 in the step B1*, the step B3* is performed. Whereas, if the number of face images contained in the photo files is 0 in the step B1*, the step B4* is performed. If the facial feature is successfully captured in the step B5*, the step B7* is performed. Whereas, if no facial feature is captured in the step B5*, the step B6* is performed. If the judging condition of the step B7* is satisfied, the step B8* is performed. Whereas, if the judging condition of the step B7* is not satisfied, the step B9* is performed.

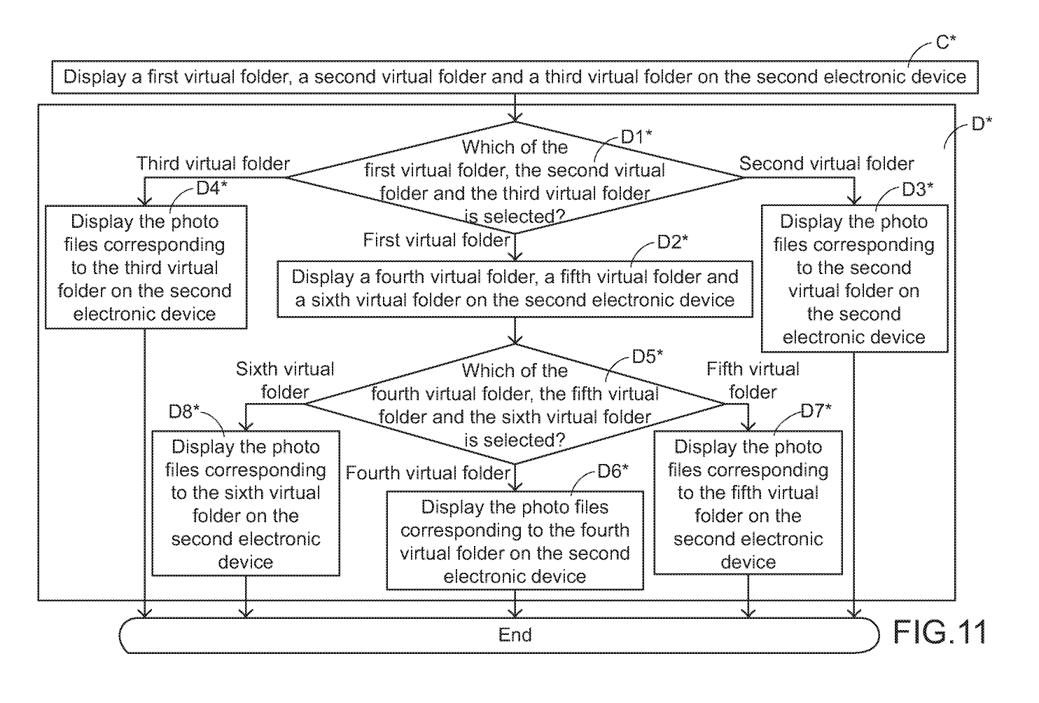

FIG. 11 is a flowchart illustrating the step D* of the photo file displaying method according to the second embodiment of the present invention. The step D* comprises the following steps D1*˜D8*. In the steps D1*, the first virtual folder, the second virtual folder or the third virtual folder is selected. In the step D2*, a fourth virtual folder, a fifth virtual folder and a sixth virtual folder are displayed on the second electronic device. In the step D3*, the photo files corresponding to the second virtual folder are displayed on the second electronic device. In the step D4*, the photo files corresponding to the third virtual folder are displayed on the second electronic device. In the step D5*, the fourth virtual folder, the fifth virtual folder or the sixth virtual folder is selected. In the step D6*, the photo files corresponding to the fourth virtual folder are displayed on the second electronic device. In the step D7*, the photo files corresponding to the fifth virtual folder are displayed on the second electronic device. In the step D8*, the photo files corresponding to the sixth virtual folder are displayed on the second electronic device.

If the first virtual folder is selected in the step D1*, the step D2* is performed. Whereas, if the second virtual folder is selected in the step D1*, the step D3* is performed. Whereas, if the third virtual folder is selected in the step D1*, the step D4* is performed. If the fourth virtual folder is selected in the step D5*, the step D6* is performed. Whereas, if the fifth virtual folder is selected in the step D5*, the step D7* is performed. Whereas, if the sixth virtual folder is selected in the step D5*, the step D8* is performed.

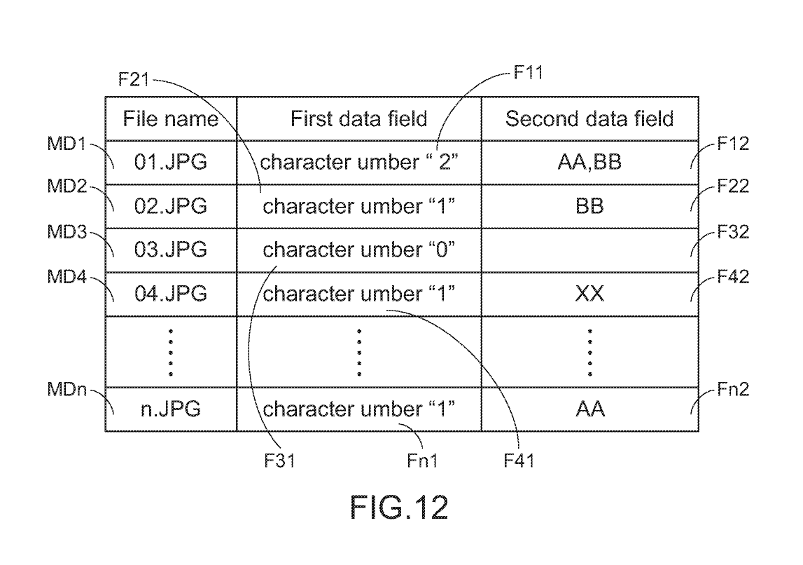

Hereinafter, the detailed procedure of the photo file displaying method performed by the DLNA system 5 will be illustrated with reference to FIGS. 8˜11. Similar to the first embodiment, plural photo files M1˜Mn are stored into the storage element 511 of the first electronic device 51. The file names of the plural photo files M1˜Mn are 01.JPG˜n.JPG, respectively (see FIG. 12). The website address of the photo file M1 stored in the first electronic device 51 is http:\\DMS\Photo\01.JPG. The website address of the photo file M2 stored in the first electronic device 51 is http:\\DMS\Photo\02.JPG. The rest may be deduced by analogy. In this embodiment, the first electronic device 51 does not have the default photo folder.

After the photo file displaying method is started by the DLNA system 5 of the present invention, the step A* and the step B1* are performed. That is, the face analysis module 512 performs the face detection operations on the plural photo files M1˜Mn of the storage element 511 sequentially, and the face analysis module 512 judges the number of face images contained in the photo files M1˜Mn. If the face analysis module 512 judges that the number of face images contained in the photo file M1 is 2, the second photo property is written into a first data field F11 of the metadata MD1 of the photo file M1. The second photo property is a character number “2”. That is, the step B3* is performed. After the step B3*, the face analysis module 512 captures the facial features of the face images of the photo file M1 and judge whether the facial features are successfully captured. That is, the step B5* is performed. If two face features are successfully captured from the photo file M1 by the face analysis module 512, the step B7* is performed. In the step B7*, the face analysis module 512 judges whether the two facial features comply with the default facial feature Fc1. If the face analysis module 512 judges that the first facial feature comply with the default facial feature Fc1, a first facial feature information corresponding to the first facial feature is written into a second data field F12 of the metadata MD1 of the photo file M1. That is, the step B8* is performed. Whereas, if the face analysis module 512 judges that the second facial feature does not comply with the default facial feature Fc1, another (or a second) default facial feature Fc2 complying with the second facial feature is newly added to the storage element 511, and a second facial feature information corresponding second facial feature is written into the second data field F12 of the metadata MD1 of the photo file M1. That is, the step B9* is performed. Meanwhile, the face detection operation on the photo file M1 is completed.

Then, the face analysis module 512 performs the face detection operation on the photo file M2. If the face analysis module 512 judges that the number of face images contained in the photo file M2 is 1, the first photo property is written into a first data field F21 of the metadata MD2 of the photo file M2. The first photo property is a character number “1”. That is, the step B2* is performed. Then, the step B5* and the step B7* are sequentially performed. In the step B7*, if the face analysis module 512 judges whether the facial feature in the photo file M2 does not comply with the default facial feature Fc1, the face analysis module 512 further judges whether the facial feature in the photo file M2 complies with the default second facial feature Fc2. That is, the step B9* is not directly performed. If the face analysis module 512 judges that the facial feature in the photo file M2 complies with the default second facial feature Fc2, the second facial feature information is written into the second data field F22 of the metadata MD2 of the photo file M2. That is, the step B8* is performed.

Then, the face analysis module 512 performs the face detection operation on the photo file M3. If the face analysis module 512 judges that the number of face images contained in the photo file M3 is 0, the third photo property is written into a first data field F31 of the metadata MD3 of the photo file M3. The third photo property is a character number “0”. That is, the step B4* is performed.

Then, the face analysis module 512 performs the face detection operation on the photo file M4. Then, the step B2* and the step B5* are sequentially performed. In the step B2*, the first photo property is written into a first data field F41 of the metadata MD4 of the photo file M4 by the controlling unit 513. In the step B5*, if no face feature is successfully captured from the photo file M4 by the face analysis module 512, the no facial feature information is written into a second data field F42 of the metadata MD4 of the photo file M4 by the controlling unit 513. That is, the step B6* is performed. The ways of processing the remaining photo files are similar to the above steps, and are not redundantly described herein.

After the face detection operations on the plural photo files M1˜Mn are completed, plural metadata MD1˜MDn are obtained (see FIG. 12). As shown in FIG. 12, the first facial feature information is denoted as “AA”, the second facial feature information is denoted as “BB”, and the no facial feature information is denoted as “XX”. Since the photo file does not contain any face image and facial feature, the second data field F32 of the metadata MD3 is blank.

After the data fields of the plural metadata MD1˜MDn are set, if the second electronic device 52 is connected to the first electronic device 51 via the network router 50 through network connection, the plural metadata MD1˜MDn are classified into three groups by the controlling unit 513 of the first electronic device 51 according to the first data fields F11˜Fn1 of the plural metadata MD1˜MDn. In this embodiment, the plural photo files M1˜Mn are classified into three groups according to the number of characters contained in each photo file. For example, the photo file with 1 character belongs to the first group (i.e. character number=1); the photo file with 2 or more characters belongs to the second group (i.e. character number 2); and photo file with no character belongs to the third group (i.e. character number=0). That is, the first data fields F11˜Fn1 shown in FIG. 12 are classified into three groups (i.e. character number=1, character number 2 and character number=0) by the controlling unit 513, and the plural metadata MD1˜MDn are classified into three groups. Consequently, the plural photo files M1˜Mn are classified into three groups. According to the above classification, the controlling unit 513 generates a first folder packet Pc1. The first folder packet Pc1 is transmitted to the second electronic device 52. According to the first folder packet Pc1, the first virtual folder Fv1, the second virtual folder Fv2 and the third virtual folder Fv3 are displayed on the display screen 521 of the second electronic device 52. The first virtual folder Fv1 contains plural photo files with one character. That is, the first virtual folder Fv1 is a single character folder. The second virtual folder Fv2 contains plural photo files with two or more characters. That is, the second virtual folder Fv2 is a multi-character folder. The third virtual folder Fv3 contains plural photo files with zero character. That is, the third virtual folder Fv3 is a non-character folder (or a scenic photo folder). Meanwhile, the step C* is completed.

In the step D1*, if the first virtual folder Fv1 is selected by the user via the operation interface 522 of the second electronic device 52, the second electronic device 52 issues a first select signal O1 to the first electronic device 51. In response to the first select signal O1, the plural photo files M1˜Mn are classified into three groups by the controlling unit 513 according to the second data fields F12˜Fn2 of the plural metadata MD1˜MDn. The photo files containing the first facial feature belong to the first group. In addition, the photo files having the first facial feature information is assigned to the fourth virtual folder, the photo files having the second facial feature information is assigned to the fifth virtual folder, and the photo files having the no facial feature information is assigned to the sixth virtual folder. According to the above classification, the controlling unit 513 generates a second folder packet Pc2. The second folder packet Pc2 is transmitted to the second electronic device 52. In response to the second folder packet Pc2, the fourth virtual folder Fv4, the fifth virtual folder Fv5 and the sixth virtual folder Fv6 are displayed on the display screen 521 of the second electronic device 52. That is, the step D2* is performed.

In the step D5*, if the fourth virtual folder Fv4 is selected by the user via the operation interface 522 of the second electronic device 52, the second electronic device 52 issues a second select signal O2 to the first electronic device 51. In response to the second select signal O2, the plural photo files having the first facial feature information (including the photo files Mn, . . . ) are acquired and formed as a first list packet P1 by the controlling unit 513, and the first list packet P1 is transmitted to the second electronic device 52. In response to the first list packet P1, the plural photo files (including the photo files Mn, . . . ) corresponding to the fourth virtual folder Fv4 are displayed on the display screen 521 of the second electronic device 52. That is, the step D6* is performed. The website address of the photo file Mn displayed on the second electronic device 52 is http:\\DMS\ first virtual folder\fourth virtual folder\n.JPG. The ways of selecting and displaying the remaining virtual folders are similar to those mentioned above and can be deduced from the descriptions of FIGS. 9˜11, and are not redundantly described herein.

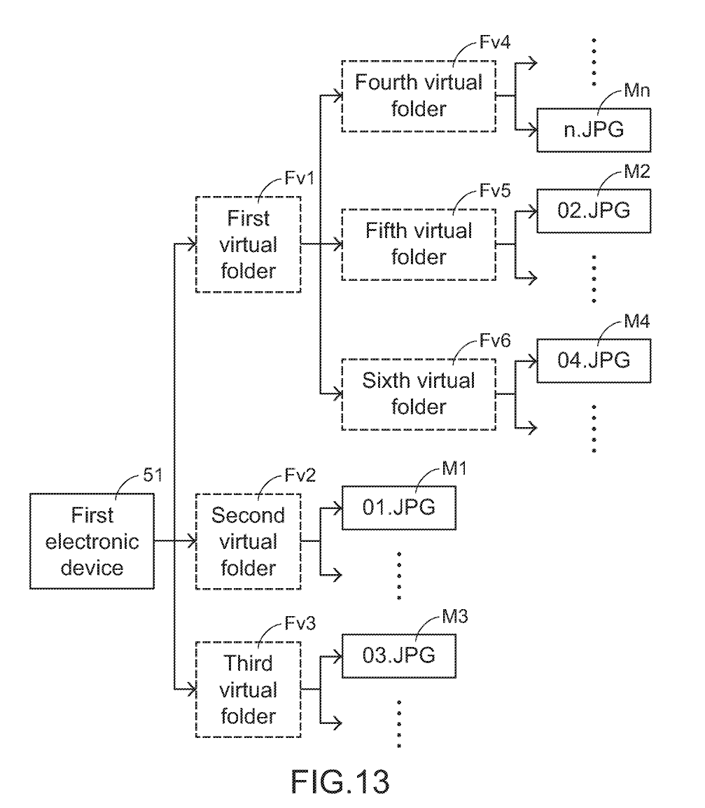

From the above discussions, the DLNA system 5 of the present invention is capable of classifying the plural photo files M1˜Mn by implementing the photo file displaying method of the present invention. FIG. 13 schematically illustrates the folder architecture of the first electronic device of the DLNA system according to the second embodiment of the present invention. The folder architecture of the first electronic device 51 is clearly shown in FIG. 13. The first storage element 511 of the first electronic device 51 contains the virtual folders Fv1˜Fv6 (indicated by dotted line), which are practically non-existing. The plural photo files containing the single face image are assigned to the first virtual folder Fv1. That is, the first virtual folder Fv1 is a face image folder. The plural photo files containing the plural face images are assigned to the second virtual folder Fv2. That is, the second virtual folder Fv2 is also a face image folder. The plural photo files without containing the face image are assigned to the third virtual folder Fv3. That is, the third virtual folder Fv3 is a scenic photo folder. The first virtual folder Fv1 is further divided into the fourth virtual folder Fv4, the fifth virtual folder Fv5 and the sixth virtual folder Fv6. The plural photo files containing the first facial feature information are assigned to the fourth virtual folder Fv4. The plural photo files containing the second facial feature information are assigned to the fifth virtual folder Fv5. The plural photo files containing the third facial feature information are assigned to the sixth virtual folder Fv6.

From the above discussions, the photo file M1 and other photo files corresponding to the second virtual folder Fv2 may be displayed by performing the step D1* and the step D3*; the photo file M3 and other photo files corresponding to the third virtual folder Fv3 may be displayed by performing the step D1* and the step D4*; the photo file Mn and other photo files corresponding to the fourth virtual folder Fv4 may be displayed by performing the step D1*, the step D2*, the step D5* and the step D6*; the photo file M2 and other photo files corresponding to the fifth virtual folder Fv5 may be displayed by performing the step D1*, the step D2*, the step D5* and the step D7*; and the photo file M4 and other photo files corresponding to the sixth virtual folder Fv6 may be displayed by performing the step D1*, the step D2*, the step D5* and the step D8*.

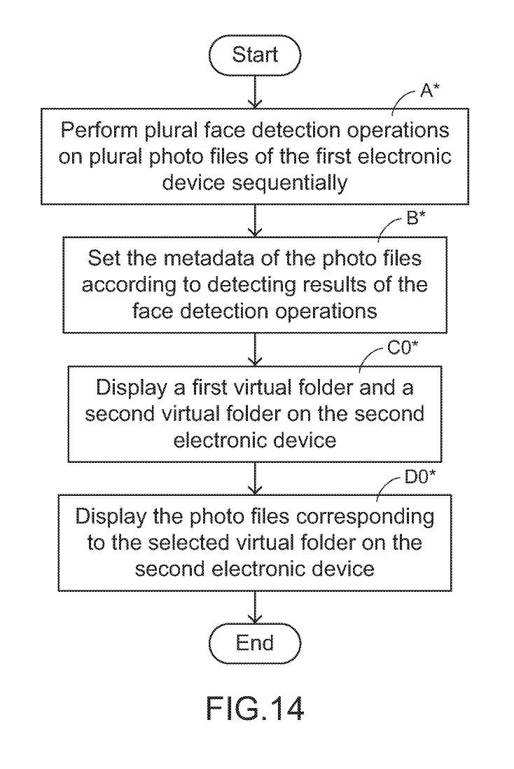

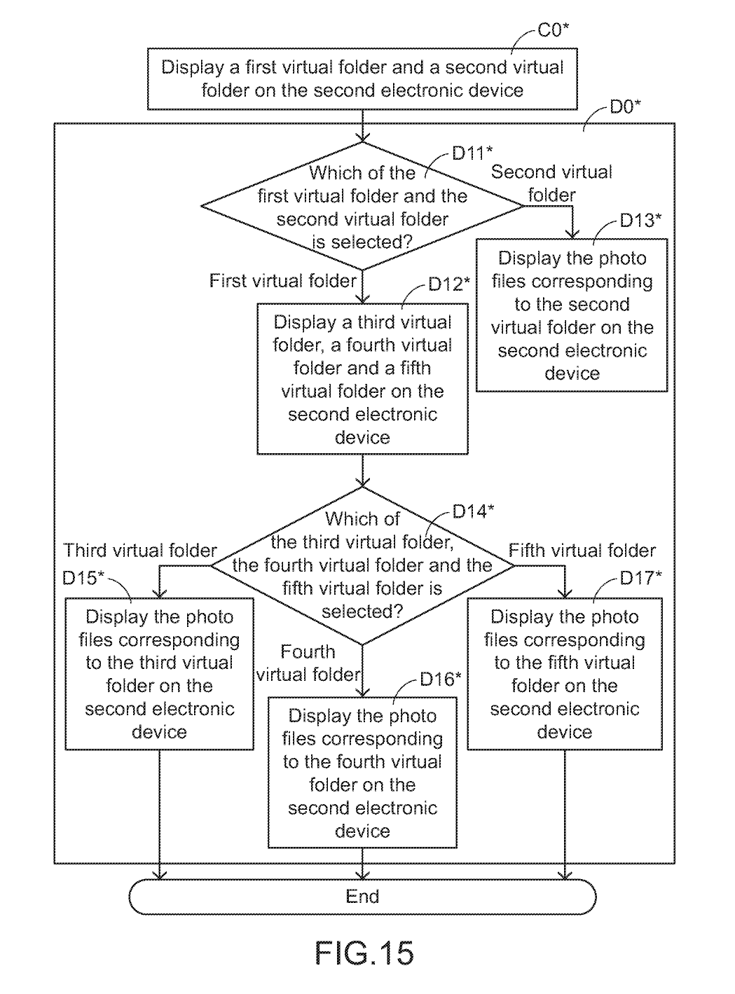

Hereinafter, another photo file displaying method according to the present invention will be illustrated with reference to FIGS. 8, 14 and 15. FIG. 14 is a flowchart illustrating a photo file displaying method according to a third embodiment of the present invention. FIG. 15 is a flowchart illustrating the step D* of the photo file displaying method according to the third embodiment of the present invention. The architecture of the DLNA system for implementing the photo file displaying method of this embodiment is identical to the architecture of the DLNA system 5 of the second embodiment. In other words, the architecture of the DLNA system shown in FIG. 8 may be applied to the photo file displaying method of this embodiment. As shown in FIG. 14, the photo file displaying method comprises the following steps.

Firstly, in a step A*, plural face detection operations are performed on plural photo files of the first electronic device sequentially. Then, in a step B*, the metadata of the photo files are set according to the detecting results of the face detection operations. In a step C0*, a first virtual folder and a second virtual folder are displayed on the second electronic device. In a step D0*, the photo files corresponding to the selected virtual folder are displayed on the second electronic device.

In comparison with the photo file displaying method of the second embodiment, the step C0* and the step D0* of the photo file displaying method of this embodiment are distinguished. The step A* and the step B* of the photo file displaying method of this embodiment are similar to those of the photo file displaying method of the second embodiment, and are not redundantly. As shown in FIG. 15, the step D* comprises the steps D11*˜D17*. In the steps D11*, the first virtual folder or the second virtual folder is selected. In the step D12*, a third virtual folder, a fourth virtual folder and a fifth virtual folder are displayed on the second electronic device. In the step D13*, the photo files corresponding to the second virtual folder are displayed on the second electronic device. In the step D14*, the third virtual folder, the fourth virtual folder or the fifth virtual folder is selected. In the step D15*, the photo files corresponding to the third virtual folder are displayed on the second electronic device. In the step D16*, the photo files corresponding to the fourth virtual folder are displayed on the second electronic device. In the step D17*, the photo files corresponding to the fifth virtual folder are displayed on the second electronic device.

If the first virtual folder is selected in the step D11*, the step D12* is performed. Whereas, if the second virtual folder is selected in the step D11*, the step D13* is performed. Whereas, if the third virtual folder is selected in the step D14*, the step D15* is performed. If the fourth virtual folder is selected in the step D14*, the step D16* is performed. Whereas, if the fifth virtual folder is selected in the step D14*, the step D17* is performed.

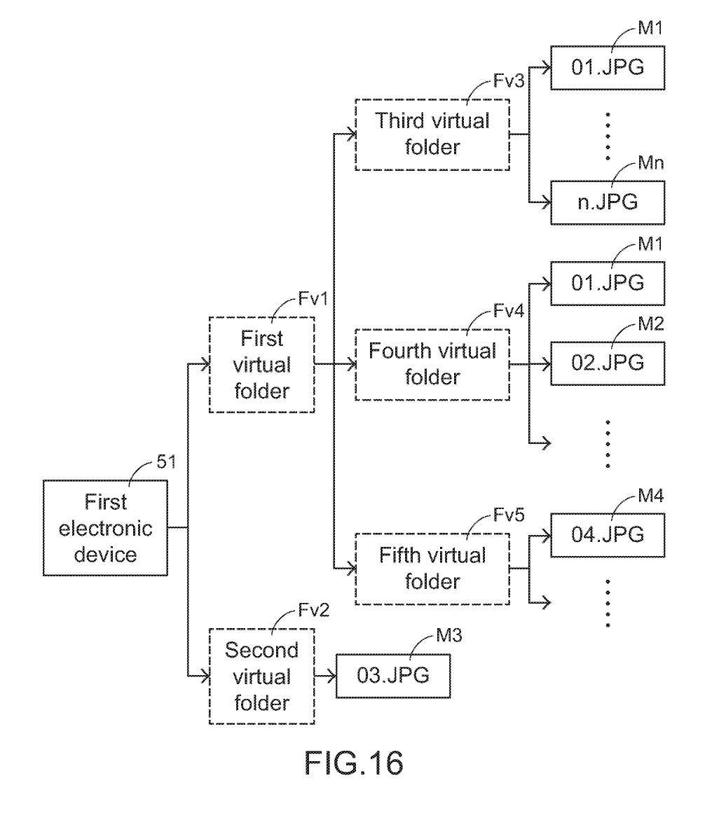

The settings of the controlling unit 513 of this embodiment are different from the settings of the controlling unit 513 of the second embodiment. Consequently, the DLNA system 5 of the present invention is capable of classifying the plural photo files M1˜Mn by implementing the photo file displaying method of this embodiment. The folder architecture of the first electronic device 51 is clearly shown in FIG. 16. The first storage element 511 of the first electronic device 51 contains the virtual folders Fv1˜Fv5 (indicated by dotted line), which are practically non-existing. The plural photo files containing the face image are assigned to the first virtual folder Fv1. That is, the first virtual folder Fv1 is a face image folder. The plural photo files containing the plural face images are assigned to the second virtual folder Fv2. That is, the second virtual folder Fv2 is a scenic photo folder. The first virtual folder Fv1 is further divided into the third virtual folder Fv3, the fourth virtual folder Fv4 and the fifth virtual folder Fv5. The plural photo files containing the first facial feature information are assigned to the third virtual folder Fv3. The plural photo files containing the second facial feature information are assigned to the fourth virtual folder Fv4. The plural photo files containing the third facial feature information are assigned to the fifth virtual folder Fv5.

From the above discussions, the photo file M3 and other photo files corresponding to the second virtual folder Fv2 may be displayed by performing the step D11* and the step D13*; the photo file M1 and other photo files corresponding to the third virtual folder Fv3 may be displayed by performing the step D11*, the step D12*, the step D14* and the step D15*; the photo file Mn and other photo files corresponding to the fourth virtual folder Fv4 may be displayed by performing the step D11*, the step D12*, the step D14* and the step D16*; or the photo file M2 and other photo files corresponding to the fifth virtual folder Fv5 may be displayed by performing the step D11*, the step D12*, the step D14* and the step D17*.

Since the settings of the controlling unit 513 of this embodiment are different from the settings of the controlling unit 513 of the second embodiment, the virtual folder corresponding to the plural face images is not included in this embodiment. As shown in FIG. 16, the photo file M1 is assigned to the third virtual folder Fv3 and the fourth virtual folder Fv4 simultaneously. That is, if the third virtual folder Fv3 is selected by the user via the second electronic device 52, the photo file M1 corresponding to the third virtual folder Fv3 is displayed on the second electronic device 52. Whereas, if the fourth virtual folder Fv4 is selected by the user via the second electronic device 52, the photo file M1 corresponding to the fourth virtual folder Fv4 is displayed on the second electronic device 52. In case that each virtual folder is selected, the photo files corresponding to the virtual folder are displayed. In addition, the same photo file corresponding to different virtual folders may be browsed by the user. However, the storage element 511 of the first electronic device 51 does not store two photo files M 1. In fact, by the photo file displaying method of the present invention, one photo file may be assigned to plural virtual folders. Consequently, only one photo file M1 is stored in the storage element 511, and the same photo file corresponding to different virtual folders may be browsed by the user. Since it is not necessary to store the replicate of each photo file in the storage element 511, the storing space of the storage element 511 is largely saved.

From the above descriptions, the present invention provides a DLNA system and a photo file displaying method. According to the detecting results of the face detection operations, the metadata of plural photo files are set. When the user operates a digital media controller or a digital media player to browse plural photo files, the metadata are classified into plural groups, and plural virtual folders are displayed on a digital media server according to the classification. Each of the virtual folders contains the photo folders having the photo property corresponding to the metadata. Consequently, plural photo files with the same photo property are assigned to the same virtual folder. In other words, the photo file displaying method of the present invention may facilitate the user to browse the plural photo files and easily search the desired photo file. Moreover, by the photo file displaying method of the present invention, one photo file may be assigned to plural virtual folders. Since it is not necessary to store the replicate of each photo file in the digital media server, the storing space of the storage element is largely saved.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A photo file displaying method for a DLNA system, the photo file displaying method comprising steps of:
(A) performing a face detection operation on a photo file of a first electronic device;
(B) writing a first photo property or a second photo property into a data field of a metadata of the photo file according to a result of the face detection operation;
(C) displaying a first virtual folder and a second virtual folder on a second electronic device, wherein if the photo file has the first photo property, the photo file is assigned to the first virtual folder, wherein if the photo file has the second photo property, the photo file is assigned to the second virtual folder; and
(D) if the first virtual folder or the second virtual folder is selected, displaying the photo file corresponding to the first virtual folder or the second virtual folder on the second electronic device.

2. The photo file displaying method according to claim 1, wherein if at least one face image contained in the photo file is detected, the step (B) is performed by writing the first photo property into a first data field of the metadata, wherein if no face image contained in the photo file is detected, the step (B) is performed by writing the second photo property into the first data field of the metadata, wherein the first photo property is a character photo property, and the second photo property is a non-character photo property.

3. The photo file displaying method according to claim 2, wherein if at least one face image contained in the photo file is detected and a first facial feature is acquired from the at least one face image, the step (B) is performed by further writing a first facial feature information into a second data field of the metadata, wherein if at least one face image contained in the photo file is detected and a second facial feature is acquired from the at least one face image, the step (B) is performed by further writing a second facial feature information into the second data field of the metadata, wherein if at least one face image contained in the photo file is detected and no facial feature is acquired from the at least one face image, the step (B) is performed by further writing a no facial feature information into the second data field of the metadata.

4. The photo file displaying method according to claim 3, wherein the step (D) comprises steps of:
(D1) if the first virtual folder is selected, displaying the photo file corresponding to the first virtual folder on the second electronic device;
(D2) if the second virtual folder is selected, displaying the photo file corresponding to the second virtual folder on the second electronic device;
(D3) if the first virtual folder is selected, displaying a third virtual folder, a fourth virtual folder and a fifth virtual folder on the second electronic device, wherein if the photo file has the first facial feature information, the photo file is assigned to the third virtual folder, wherein if the photo file has the second facial feature information, the photo file is assigned to the fourth virtual folder, wherein if the photo file has the no facial feature information, the photo file is assigned to the fifth virtual folder;
(D4) if the third virtual folder is selected, displaying the photo file corresponding to the third virtual folder on the second electronic device;
(D5) if the fourth virtual folder is selected, displaying the photo file corresponding to the fourth virtual folder on the second electronic device;
(D6) if the fifth virtual folder is selected, displaying the photo file corresponding to the fifth virtual folder on the second electronic device.

5. The photo file displaying method according to claim 1, wherein if only one face image contained in the photo file is detected, the step (B) is performed by writing the first photo property into a first data field of the metadata, wherein if two face images contained in the photo file is detected, the step (B) is performed by writing the second photo property into the first data field of the metadata, wherein if no face image contained in the photo file is detected, the step (B) is performed by writing a third photo property into the first data field of the metadata, wherein the first photo property is a character number “1”, the second photo property is a character number “2”, and the third photo property is a character number “0”.

6. The photo file displaying method according to claim 5, wherein if at least one face image contained in the photo file is detected and a first facial feature is acquired from the at least one face image, the step (B) is performed by further writing a first facial feature information into a second data field of the metadata, wherein if at least one face image contained in the photo file is detected and a second facial feature is acquired from the at least one face image, the step (B) is performed by further writing a second facial feature information into the second data field of the metadata, wherein if at least one face image contained in the photo file is detected and the first facial feature and the second facial feature are acquired from the at least one face image, the step (B) is performed by further writing the first facial feature information and the second facial feature information into the second data field of the metadata, wherein if at least one face image contained in the photo file is detected and no facial feature is acquired from the at least one face image, the step (B) is performed by further writing a no facial feature information into the second data field of the metadata.

7. The photo file displaying method according to claim 1, wherein the first electronic device is a digital media server according to a DLNA protocol, and the second electronic device is a digital media controller or a digital media player according to the DLNA protocol.

8. A DLNA system for displaying a photo file, the DLNA system comprising:
a network router providing a network connection function;
a digital media server connected to the network router through network connection and storing the photo file, wherein the digital media server comprises a storage element, a face analysis module and a controlling unit, wherein the storage element is disposed within the digital media server for storing the photo file, wherein the face analysis module is connected with the storage element, and the face analysis module detects whether at least one face image is contained in the photo file, wherein the controlling unit is connected with the face analysis module, and the controlling unit writes a first photo property or a second photo property into a metadata of the photo file according to a detecting result of the face analysis module, wherein if the photo file has the first photo property, the photo file is assigned to the first virtual folder, wherein if the photo file has the second photo property, the photo file is assigned to the second virtual folder; and
an electronic device connected to the network router through network connection and connected to the digital media server via the network router through network connection, wherein the first virtual folder and the second virtual folder are displayed on the electronic device, wherein if the first virtual folder or the second virtual folder is selected, the photo file corresponding to the first virtual folder or the second virtual folder is displayed on the electronic device.

9. The DLNA system according to claim 8, wherein if at least one face image contained in the photo file is detected by the face analysis module, the controlling unit writes the first photo property into a first data field of the metadata, wherein if no face image contained in the photo file is detected by the face analysis module, the controlling unit writes the second photo property into the first data field of the metadata.

10. The DLNA system according to claim 8, wherein if at least one face image contained in the photo file is detected by the face analysis module and a first facial feature is acquired from the at least one face image, the controlling unit writes a first facial feature information into a second data field of the metadata, wherein if at least one face image contained in the photo file is detected by the face analysis module and a second facial feature is acquired from the at least one face image, the controlling unit writes a second facial feature information into the second data field of the metadata, wherein if at least one face image contained in the photo file is detected by the face analysis module and no facial feature is acquired from the at least one face image, the controlling unit writes a no facial feature information into the second data field of the metadata.

11. The DLNA system according to claim 10,
wherein if the first virtual folder is selected, the photo file having the first photo property is acquired and formed as a first list packet by the controlling unit, and the first list packet is transmitted from the controlling unit to the electronic device, so that the photo file corresponding to the first virtual folder is displayed on the electronic device;
wherein if the second virtual folder is selected, the photo file having the second photo property is acquired and formed as a second list packet by the controlling unit, and the second list packet is transmitted from the controlling unit to the electronic device, so that the photo file corresponding to the second virtual folder is displayed on the electronic device;
wherein if the first virtual folder is selected, a third virtual folder, a fourth virtual folder and a fifth virtual folder are displayed on the electronic device, wherein if the photo file has the first facial feature information, the photo file is assigned to the third virtual folder, wherein if the photo file has the second facial feature information, the photo file is assigned to the fourth virtual folder, wherein if the photo file has the no facial feature information, the photo file is assigned to the fifth virtual folder;
wherein if the third virtual folder is selected, the photo file having the first facial feature information is acquired and formed as a third list packet by the controlling unit, and the third list packet is transmitted from the controlling unit to the electronic device, so that the photo file corresponding to the third virtual folder is displayed on the electronic device;
wherein if the fourth virtual folder is selected, the photo file having the second facial feature information is acquired and formed as a fourth list packet by the controlling unit, and the fourth list packet is transmitted from the controlling unit to the electronic device, so that the photo file corresponding to the fourth virtual folder is displayed on the electronic device; and
wherein if the fifth virtual folder is selected, the photo file having the no facial feature information is acquired and formed as a fifth list packet by the controlling unit, and the fifth list packet is transmitted from the controlling unit to the electronic device, so that the photo file corresponding to the fifth virtual folder is displayed on the electronic device;

12. The DLNA system according to claim 8, wherein the electronic device is a digital media controller or a digital media player.
